(19) United States
(12) Patent Application Publication
(10) Pub. No.: US 2015/0284141 A1
(43) Pub. Date: Oct. 8, 2015

(54) Anti-Static Articles and Materials

(71) Applicant: Yonghao NI, (US)

(72) Inventor: Yonghao Ni, Fredericton (CA)

(21) Appl. No.: 14/441,940

(22) PCT Filed: Nov. 8, 2013
(86) PCT No.: PCT/CA2013/000943

§ 371 Date: May 11, 2015

Related U.S. Application Data
(60) Provisional application No. 61/724,562, filed on Nov. 9, 2012.
(60) Provisional application No. 61/809,923, filed on Apr. 9, 2013.

(51) Int. Cl. B65D 30/00; H01B 1/12; B65D 27/00

(52) U.S. Cl. CPC B65D 31/005; B65D 27/005; H01B 1/127; B65D 2213/02; B65D 2585/86

(57) ABSTRACT

The present disclosure relates to anti-static articles and multi-layered materials comprising an electrically conductive layer and a support layer.

### RELATED APPLICATIONS

This application claims priority to U.S. Provisional Patent Application Nos. 61/724,562 and 61/809,923 filed on Nov. 9, 2012 and Apr. 9, 2013, respectively, the content of each of which are hereby incorporated by reference in their entirety.

### FIELD

The present disclosure relates to anti-static articles and multi-layered materials comprising an electrically conductive layer and a support layer.

### BACKGROUND

During the handling, storage and/or transportation of delicate electronic devices, protection is needed from electrostatic discharge, physical shock/vibration, electric/magnetic fields etc. Further, electronic chips are handled many times during each state of assembly. In order to prevent the damage of these electronics, electrostatic discharge (ESD) protection materials are needed to protect against contamination and charge build-up. Traditionally, plastic bags have been used in the industry for the ESD market; however the plastic bags are not biodegradable/recyclable.

### SUMMARY

This application relates to anti-static articles which protect devices which are sensitive to electrostatic discharge and/or shock.

In one embodiment, there is provided an anti-static article comprising:
i) an electrically conductive layer comprising an electrically conductive polymer or an electrically conductive polymer composite; and
ii) a support layer.

In other embodiments, there is also included an anti-static bag, comprising,
i) an electrically conductive layer comprising an electrically conductive polymer or an electrically conductive polymer composite; and
ii) a support layer.

In another embodiment, the present disclosure also includes an anti-static bag, comprising,
i) a first electrically conductive layer comprising an electrically conductive polymer or an electrically conductive polymer composite;
ii) a heat sealable polymer layer;
iii) a first support layer;
iv) a vapor barrier layer;
v) a second support layer; and
vi) a second electrically conductive layer comprising an electrically conductive polymer or an electrically conductive polymer composite.

The present disclosure also includes a multi-layered material comprising,
i) an electrically conductive layer as defined herein; and
ii) a support layer as defined herein.

Further aspects and advantages of the embodiments described herein will appear from the following description taken together with the accompanying drawing.

### BRIEF DESCRIPTION OF THE DRAWINGS

For a better understanding of the embodiments described herein and to show more clearly how they may be carried into effect, reference will now be made, by way of example only, to the accompanying drawings which shows at least one exemplary embodiment, and in which:

FIGS. 1(a) and (b) shows a schematic representation of an article in accordance with the disclosure;

FIG. 2 shows a cross-sectional view of a material in an embodiment of the disclosure; and

FIGS. 3 (a) and (b) shows photographs of an article in an embodiment of the disclosure.

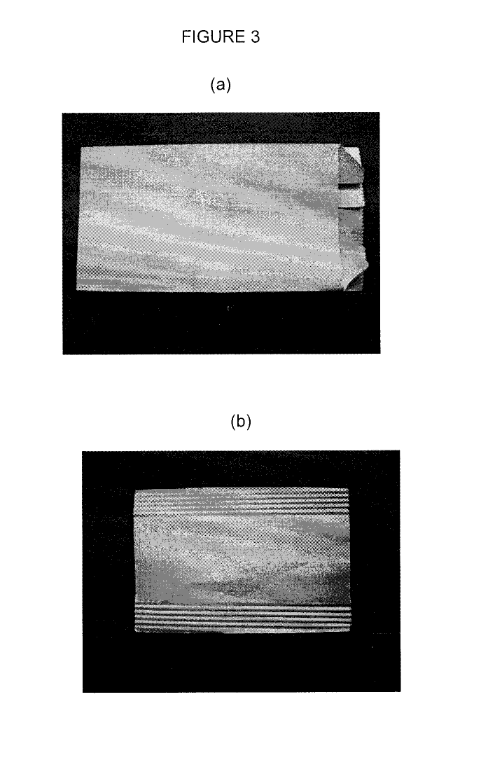

### DETAILED DESCRIPTION

### (I) Definitions

The term “anti-static” as used herein refers to an article or material of the present disclosure which can dissipate an electrical charge, such as a static electrical charge. The anti-static article protects any device, such as an electronic device, which is susceptible to damage by an electrical charge such that the device is not harmed or affected by the electrostatic discharge.

The term “article” as used herein refers to any physical object which protects a device, such as an electronic device, from electrical discharge, during the manufacture, use, packaging, transportation etc., of the device. Examples of articles, include, but are not limited to, bags, pouches, envelopes, sacks, boxes, cartons, containers, wrapping, packaging materials, fill products (such as void sheets, packing peanuts), foams etc.

The term “electronic device” as used herein refers to both finished consumer products as well as modular devices, parts or components to be incorporated into products. Electronic components include any type of structure which is incorporated into an electronic device, and includes, but is not limited to, printed wiring boards, integrated circuits, discrete components, connectors, flex circuits, displays, I/O interfaces, keypads and other input devices, and housings.

The term “multi-layered material” as used herein refers to a combination of separate and distinct layers to form a material having anti-static properties.

The term “electrically conductive layer” as used herein refers to a distinct layer formed from materials which are able to dissipate an electrical charge, for example, a static electrical charge.

The term “electrically conductive polymer” as used herein refers to any polymer which is inherently or intrinsically capable of electrical conductivity without the addition of other conductive dopants, and therefore has a measurable level of electrical conductivity.

The term “electrically conductive filled polymer” as used herein refers to any polymer to which has been added (doped) a conductive material or fillers, such as graphite, carbon black, carbon fibrils or carbon fibers, nanofiber, and carbon nanotubes, which when added to a conductive or a nonconductive polymer produces an electrically conductive polymer.

The term “conjugated conducting polymer” as used refers to a polymer having an extended system of alternating single and double-bonds and/or triple bonds, i. e. an extended π-system, and which is therefore able to conduct an electrical charge.

The term “ionically conductive polymer”, or “charged polymer”, as used herein refers to a polymer which possesses an inherent positive (cationic) or negative (anionic) charge.

The term “polymer” as used herein has its normal meaning and refers to a macromolecular substance composed of one or more repeating monomers, and includes linear, branched, and cross-linked polymers, and combinations thereof. The polymer can comprise copolymers, block copolymers, graft copolymers, alternating copolymers, and random copolymers.

The term “charge transfer polymer” as used herein refers to a polymer complex which conducts an electrical charge as a result of electron transfer between an electron donor (D) and acceptor (A) molecules.

The term “composite” as used herein refers to a material in which the presence of two or more constituent materials remains separate and distinct within the finished material, in which one of the materials is electrically conductive.

The term “support layer”, as used herein, refers to the layer that provides mechanical support for the electrically conductive layer. Typically, the support layer is not involved in the dissipation of the static electrical charge.

### (II) Anti-Static Articles and Multi-Layered Material

The present disclosure relates to anti-static articles which are able to protect any type of device, such as an electronic device, which is susceptible to damage from an electrical discharge, such as an electrostatic discharge and/or shock. The articles of the disclosure comprise an electrically conductive layer which protects the device from electrical discharge by dissipating the electrical charge without damaging the device. In one embodiment, the articles of the present disclosure take the form of a sheet, bag, box, envelope, etc.,

Generally, electronic devices are protected from electrical shock using different protective materials which are able to dissipate an electrical shock. For example, manufacturers of electrical devices susceptible to electrical shock may protect the devices using metallic bags which dissipate the electrical charge away from the device. Also used are cardboard boxes which have been coated with conductive materials, such as carbon (carbon black), and which also dissipate the electrical charge. In addition, manufacturers of sensitive electronic devices utilize foams inside the box which also protect the device during manufacture and transportation. Due to the protective coatings on the metallic bags and boxes, they are often not recyclable or biodegradable. Manufacturers are therefore responsible for the separation and disposal of three separate waste streams (metallic bag, coated box and foam) which are not recyclable, and which is therefore time consuming and costly.

The present disclosure includes antistatic articles which, in one embodiment, are in the form of any type of packaging material. For example, the articles are boxes and fill sheets which protect electronic devices during manufacture and shipment. Since the articles are formed from the same recyclable material, there is no need for time consuming separation. Further, as the articles are recyclable, there is no need for costly disposal. For example, in one embodiment, an article of the disclosure may take the form of a paper fill sheet (or void) which is placed in an article in the form of a box. The electronic device is surrounded by the paper fill sheet in the box, and ready for shipping and/or transport. In other embodiments, the article is in the form of a paper fill sheet which surrounds and protects the electronic device, and the surrounded device is the placed in an article in the form of a bag or envelope. In this manner, manufacturers need only address one waste stream which is recyclable and/or biodegradable.

The present disclosure therefore includes anti-static articles comprising,
i) an electrically conductive layer comprising an electrically conductive polymer or an electrically conductive polymer composite; and
ii) a support layer.

In another embodiment, the electrically conductive layer is adjacent to the support layer.

In another embodiment, the electrically conductive layer has a surface conductivity that is sufficient to dissipate an electrical charge, such as an electrostatic charge, such that the dissipation is rapid enough to eliminate the charge from damaging the device. At the same time, an electrical charge that is dissipated too quickly may also cause damage to the device. In one embodiment, the electrically conductive layer has a surface conductivity of between 10² and 10¹⁰ ohms/square, optionally between 10² and 10⁸ ohms/square, or optionally between 10⁴ and 10⁷ ohms/square, or between 10⁴ and 10⁶ ohms/square.

In another embodiment of the disclosure, the electrically conductive layer consists substantially of an electrically conductive polymer or an electrically conductive polymer composite. In another embodiment of the disclosure, the electrically conductive layer consists essentially of an electrically conductive polymer or an electrically conductive polymer composite. In another embodiment of the disclosure, the electrically conductive layer consists of an electrically conductive polymer or an electrically conductive polymer composite. For example, the electrically conductive layer comprises more than about 1%, optionally more than about 5%, optionally more than about 10%, optionally more than about 20% of the electrically conductive polymer or an electrically conductive polymer composite. In another embodiment, the electrically conductive layer comprises between about 1-50%, optionally between about 1-30%, or optionally about 1-20%, of the electrically conductive polymer or an electrically conductive polymer composite. Any other conductive materials, dopants, pigments, dyes, binders, and/or any other material conducive for anti-static articles, optionally make up the remainder of the electrically conductive layer.

In other embodiments of the disclosure, the electrically conductive polymer comprises a conjugated conducting polymer, a charge transfer polymer, a charged polymer, an electrically conductive filled polymer, or mixtures thereof.

Conjugated conductive polymers of the disclosure comprise a conjugated π-system which is therefore able to dissipate an electrical charge. Examples of conjugated conductive polymers, include, but are not limited to, poly(phenylenevinylenes), polyfluorenes, poly(spirobifluorenes), polythiophenes, poly(p-phenylenes), poly(anilines), poly(pyrroles), copolymers thereof, or mixtures thereof, in addition to derivatives of these polymers.

In other embodiments, the electrically conductive polymer comprises a charge transfer polymer complex which conducts an electrical charge as a result of electron transfer between an electron donor (D) and acceptor (A) molecules. Examples of charge transfer polymers include tetrathiofulvalene (an electron donor) and 7,7,8,8-tetracyano-p-quinodimethane (electron acceptor).

In another embodiment, the electrically conductive polymer comprises an ionically conductive polymer (or a charged polymer), for example, a cationic polymer or an anionic polymer. Cationic polymers contain a positive charge, such as an ammonium moiety, a phosphonium moiety, or a sulphonium moiety. Such cationic groups are able to dissociate to provide opposite ionic charges resulting in subsequent ion migration between coordination sites, which are generated by the slow motion of polymer chain segments.

Examples of cationic polymers include, but are not limited to, 2-hydroxyethyl methacrylate (HEMA), 2-acrylamido-2-methylpropane sulfonic acid (AAMPS), 3-methacryloylaminopropyl-trimethyl ammonium chloride (MAPTAC), or N,N-diallyl-N,N-dimethyl ammonium chloride (DADMAC). Polymers such as DADMAC are water soluble and therefore are aqueous solutions of the polymer are simply sprayed or coated onto the support layer, and as such, environmentally hazardous organic solvents do not need to be used. In one embodiment, the electrically conductive polymers are water soluble. Further, polymers such as DADMAC are colourless, and therefore, the articles and multi-layered materials of the disclosure are prepared in any colour by the addition of the appropriate pigment or dye. In one embodiment, the electrically conductive polymers are colourless. Polymers such as DADMAC are inherently charged or ionic (positive charge), and therefore have an affinity to negatively charged support layers, such as cellulose paper layers.

Examples of anionic polymers include, but are not limited to, polyacids containing mono-, di- or tri-acid monomers or their neutralized salts. The polyacids containing di-acid units include, but are not limited to, polyvinylmethyl/maleic acid (PVM/MA) copolymer. Examples of polyacid or salt with a mono-acid unit include, but not limited to, the acrylic acid copolymers, or their salts, such as vinylpyrrolidone/acrylates/lauryl methacrylate copolymer. Anionic polymers are inherently charged or ionic (negative charge), and therefore have an affinity to positively charged support layers.

In one embodiment of the disclosure, there is included an anti-static article comprising,
i) an electrically conductive layer comprising an ionically conducting polymer (charged polymer) or an ionically conducting polymer (charged polymer) composite; and
ii) a support layer.

In other embodiments, the electrically conductive polymer comprises a doped conductive polymer. Doped conductive polymers are conductive or non-conductive polymers to which has added a conductive filler or dopant. Examples of doped conductive polymers include, but are not limited to polyaniline, polypyrrole, polyacetylene, polyparaphenylene, polythiophene, or derivatives or mixtures thereof, and wherein the conductive filler comprises 2-naphthalene sulfonic acid (NSA), 9,10-anthraquinone-2-sulfonic acid sodium salt (AQSA-Na), p-toluenesulfonic acid or its sodium salt (PTSA or PTSA-Na), benzenesulfonic acid (BSA), or dodecylbenzene sulfonic acid or its sodium salt (DBSA and DBSA-Na).

In another embodiment of the disclosure, the electrically conductive layer comprises an electrically conductive polymer composite. The term composite refers to a material which is composed of two or more substances having different physical/chemical characteristics and in which each substance retains its identity while contributing desirable properties to the whole, and in which at least one of the substances is electrically conductive. For example, the composite may comprise an electrically conductive polymer as described above as a first substance, in composite with another non-conductive material such as clay, or any other non-conductive material as described herein. Alternatively, the electrically conductive polymer composite comprises a non-conductive polymer, such as latex or a latex derivative, which acts as a binder, and a second conductive material or substance, such as conductive clay.

Accordingly, in one embodiment, the electrically conductive polymer composite comprises,
i) the electrically conductive polymer as defined herein;
ii) a pigment material; and
iii) a binder.

In another embodiment, the electrically conductive polymer composite comprises,
i) conductive clay,
ii) a binder,
iii) a pigment.

In another embodiment, the electrically conductive polymer composite comprises,
i) conductive clay,
ii) a binder such as a non-conductive polymer, such as latex,
iii) a pigment such as non-conductive clay.

The pigment material is any water insoluble particulate. Examples of pigment materials include, but are not limited to, kaolin clay, magnesium silicate, talc (hydrous magnesium silicate), titanium dioxide and barium sulphate, plastic pigment, or mixtures thereof.

The binder of the composite is any compound which aids in the cohesive nature of the composite and includes, but is not limited to, synthetic latex, starch, polyvinyl alcohol, soy protein, carboxyl methyl cellulose (CMC), or mixtures thereof. In one embodiment, the synthetic latexes made of polymers or copolymers of ethylenically unsaturated compounds, such as copolymers of the styrene and butadiene type, which possibly also have a monomer containing a carboxyl group, such as acrylic acid, itaconic acid or maleic acid, and polyvinyl acetate having monomers that contain carboxyl.

In one embodiment, the electrically conductive polymer composite comprises,
i) 0.1 to 50% of the electrically conductive polymer, or conductive clay, as defined herein;
ii) 20 to 90% of the pigment material; and
iii) 1 to 30% of the binder.

In other embodiments of the disclosure, the support layer comprises a cellulosic paper layer, hemicellulosic paper layer, a lignocellulosic layer, wood fiber, a calcium carbonate paper layer (stone paper), or a biodegradable polymer layer. Examples of biodegradable polymer layers include polycaprolactone (PCL), polyvinyl alcohol (PVOH, PVA, or PVAI), and polylactic acid or polylactide (PLA). The support layer can further be any desired colour. In certain embodiments, the support layer is a foam.

The cellulosic paper layer has a weight of between 10 to 300 grams per square meter, or between 15 to 100 grams per square meter, or between 20 to 60 grams per square meter.

The articles of the present disclosure further comprise one or more of a vapor barrier layer, a moisture barrier layer, an oxygen barrier layer, a heat sealable polymer layer, a second electrically conductive layer or a second support layer. Examples of the vapor barrier layer include, but are not limited to, aluminum foil, polypropylene, polyethylene or polyvinylidene chloride (PVDC). Examples of the heat sealable polymer layer include, but are not limited to, poly vinyl alcohol, polypropylene or polyethylene. It will be understood that certain layers may have more than one property, for example, one layer may be a moisture barrier layer and a vapour barrier layer. For example, a layer having vapour barrier and moisture barrier properties may be formed from a combination of clay and polymer, such as Barrisurf clay and latex (for example, Dow 620).

In another embodiment, the antistatic article is in the form of a bag, a box, an envelope or a fill sheet.

In other embodiments, the electrically conductive layer does not degrade or abrade from the articles of the disclosure.

In other embodiments, the disclosure includes an anti-static bag, comprising,
i) an electrically conductive layer as defined herein; and
ii) a support layer as defined herein.

In another embodiment, the disclosure includes an anti-static bag comprising,
i) a first electrically conductive layer as defined herein;
ii) a heat sealable polymer layer as defined herein;
iii) a first support layer as defined herein;
iv) a vapor barrier layer as defined herein;
v) a second support layer as defined herein; and
vi) a second electrically conductive layer as defined herein. In another embodiment, the each layers i)-vi) is adjacent to the next layer.

In one embodiment of the disclosure, the anti-static article is able to dissipate an electrical charge, such as an electrostatic discharge. In certain embodiments, the anti-static article also shields the electronic device from radio-frequency (RF) radiation.

In one embodiment, the disclosure includes an anti-static box, comprising,
i) an electrically conductive layer as defined herein; and
ii) a support layer as defined herein.

For example, when the article is a box, the support layer in one embodiment is a corrugated cellulosic paper layer (corrugated cardboard) upon which the electrically conductive layer is coated. Such boxes are used to transport, handle and/or store sensitive electronic devices.

In one embodiment, the disclosure includes an anti-static fill sheet, comprising,
i) an electrically conductive layer as defined herein; and
ii) a support layer as defined herein.

For example, when the article is a fill sheet, the support layer in one embodiment is a cellulosic paper layer upon which the electrically conductive layer is coated. Such sheets are used to fill free space in packaging materials such as boxes, envelopes, parcels etc., which may or may not be articles of the present disclosure.

In another embodiment, the present disclosure also includes a multi-layered material comprising,
i) an electrically conductive layer as defined herein including all of the embodiments described above; and
ii) a support layer as defined herein including all of the embodiments described above.

In another embodiment, the multi-layered material is converted into any of the articles of the present disclosure. The multi-layered material may be formed into articles such as bags, pouches, envelopes, sacks, boxes, cartons, containers, wrapping, packaging materials, fill products

### (III) Process for Preparing Articles and Multi-Layered Material

The present disclosure also includes processes for preparing articles and multi-layered materials.

In one embodiment, a support layer as defined above, such as a cellulosic or lignocellulosic paper layer is coated with an electrically conductive layer as defined above, such as a charged polymer, and then subsequently dried resulting in a multi-layered material. The electrically conductive layer can be applied to the support layer by any means known in the art, for example, by coating, sizing, spraying or painting the electrically conductive polymer or electrically conductive polymer composite onto the support layer. The multi-layered material is then formed into the desired article such as an envelope, bag, pouch, box etc.

In other embodiments, when other layers are included in the material or article, the layers are coated or deposited, dried, and subsequently other layers are optionally added. For example, in one embodiment, a heat sealing polymer, such as PVA, is coated on a support layer, such as a cellulosic or lignocellulosic paper layer. The heat sealable layer is then dried. Subsequently, an electrically conductive layer is coated on the heat sealable layer and then subsequently dried, resulting in a multi-layered material comprising three layers. Other layers are optionally coated on each layer, such as oxygen barriers, moisture barriers, secondary support layers, and/or secondary electrically conductive layers.

### (IV) Methods and Uses of Articles and Multi-Layered Material

The present disclosure includes antistatic articles which, in one embodiment, are in the form of any type of packaging material. For example, the articles are in the form of boxes and fill sheets to protect electronic devices during manufacture and shipment. Since the articles are formed from the same recyclable material (multi-layered material), there is no need for time consuming separation. For example, in one embodiment, an article of the disclosure may take the form of a paper fill sheet (or void) which is placed in an article in the form of a box. The electronic device is surrounded by the paper fill sheet in the box, and ready for shipping and/or transport. In other embodiments, the article is in the form of a paper fill sheet which surrounds and protects the electronic device, and the surrounded device is the placed in an article in the form of a bag or envelope. In this manner, manufacturers need only address one waste stream which is recyclable and/or biodegradable.

Accordingly, in one embodiment, there is provided a method of reducing environmental waste comprising,
i) providing one or more electronic devices;
ii) protecting the one or more devices with one or more articles as defined herein; and
iii) removing the device from the one or more articles and generating a single waste stream formed of the articles.

Once the device has been transported in the one or more articles, the device is removed from the article, and the one or more articles form a single waste stream.

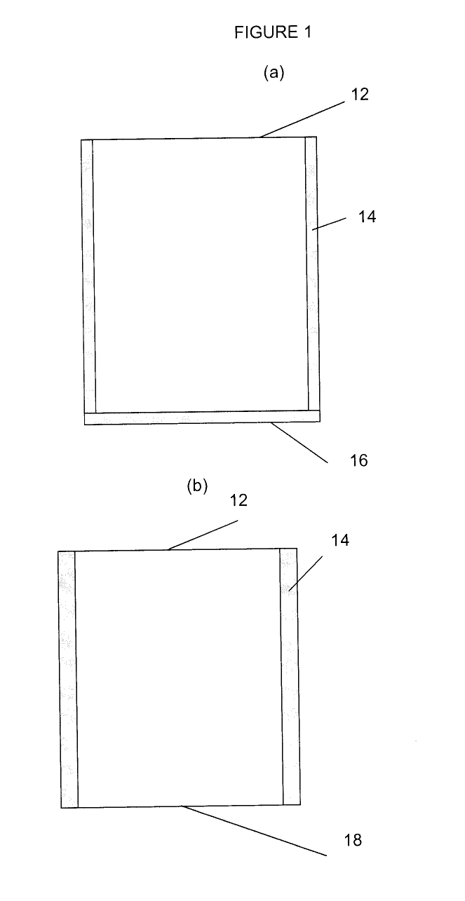

In other embodiments, the multi-layered material of the present disclosure is used to form any of the articles defined herein. For example, the multi-layered material (as a base sheet) is outlined to be formed into a standard box using methods known in the art. Likewise, the multi-layered material (as a base sheet) is folded in an appropriate manner to form a bag or an envelope. For example, two separate pieces of the multi-layered material are over-layed on each other and three sides are sealed, as seen in FIG. 1(a). The fourth edge can be sealed after an electronic device has been placed within the envelope, for example, by using a heat sealing glue or a ziplock. In one embodiment, the multi-layered material is used as a fill sheet without forming it into an article of the disclosure.

In other embodiments, the articles or multi-layered material of the present disclosure dissipate electrical charge, for example, a static electrical charge. Static electrical charges can build up during the manufacture, shipping and/or transportation of electronic devices, which can damage such devices. Accordingly, included in the present disclosure, is a method of dissipating an electrical charge, such as a static electrical charge, comprising,
i) providing one or more electronic devices;
ii) protecting the one or more electronic devices with one or more articles of the disclosure as described herein; and
iii) dissipating an electrical charge.

The present disclosure also includes a method of protecting an electronic device from static, comprising covering, typically fully covering, the electronic device with an article as defined herein, wherein external sources of static will contact the article, not the device, and the article will insulate the device from the static.

Although the disclosure has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

### EXAMPLES

The operation of the disclosure is illustrated by the following representative examples. As is apparent to those skilled in the art, many of the details of the examples may be changed while still practicing the disclosure described herein.

### Example 1

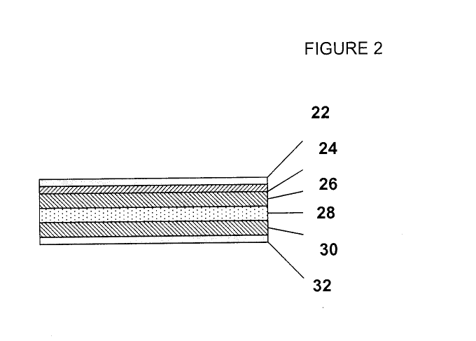

In this example, it will show that the ESD paper base sheet, which is to be converted to ESD paper bag, is made accordance with the design of FIG. 2, and then the ESD paper base sheet was converted to paper bags with the design accordance with FIG. 1. As shown in FIG. 1, there are two articles formed into bags 10 which are able to protect electronic devices. The bags both comprise an open edge 12 which allows a user to insert an electronic device into the bags. The bag in FIG. 1(a) also contains a sealed side edge 14 and a sealed bottom edge 16. The bag in FIG. 1(b) contains the sealed side edge 14 and a folded bottom edge 18.

The white paper made of bleached lignocellulosic fibers (with its basis weight of 30 gram per square meters) was covered by poly-DADMAC (about 3 grams poly-DADMAC per square meters of paper), and then dried, which is referred to as Paper A.

### Example 2

The same base paper as in Example 1 was covered by poly vinyl alcohol (PVA, a heat sealing polymer, about 5 grams per square meters), then dried, subsequently, the same poly-DADMAC was used to cover the PVA (about 3 grams poly-DADMAC per square meters of paper, the poly-DADMAC/PVA layer may be switched so that PVA is on top of poly-DADMAC), which is then referred to as Paper B.

The surface resistivity was 5×10⁵ ohms/square.

### Example 3

The final ESD paper basesheet (multi-layered material) was then assembled by Paper A (with the untreated surface facing inside and the poly-DADMAC layer facing outside), aluminium foil (about 15 grams per square meters), and Paper A (with the untreated surface facing inside and the PVA, plus the poly-DADMAC layer facing outside).

As shown in FIG. 2, the layers of the base-sheet (multi-layered material) 20, wherein 22 comprises the first electrically conductive layer, 24 is a heat sealable polymer layer, 26 is a first support layer, 28 is a vapor barrier, 30 is a second paper layer, and 32 is a second electrically conductive layer.

### Example 4

This example shows an anti-static material in which the support layer is formed from stone paper.

A stone paper (RPD80) sample was coated with a 20 g/m² solids made of 37.5% regular clay, 37.5% conductive clay and 25% latex in a pilot plant coater. The surface resistivity of the resulting product was 6.5 kΩ/sq, and its water vapor transmission rate was found to be 1.13 g/m²/24 hours.

### Example 5

This example shows an anti-static material with a barrier coating in which the support layer is formed from cellulosic paper board.

A paper liner board with 170 g/m² basis weight was first coated with a barrier layer of 22 g/m² solids made of 50% BarriSurf HX clay and 50% latex (DOW 620) to improve the water vapour barrier property, and then coated with a second conductive layer of 17 g/m² solids made of 50% conductive clay and 50% latex (DOW 620) to give the surface conductivity. The surface resistivity of the resulting product was 2.0 kΩ/sq, and its water vapor transmission rate (WVTR) was found to be 11.6 g/m²/24 hours.

While the present disclosure has been described with reference to what are presently considered to be the examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

1. An anti-static article comprising:
i) an electrically conductive layer comprising an electrically conductive polymer or an electrically conductive polymer composite; and
ii) a support layer.

2. The anti-static article according to claim 1, wherein the electrically conductive layer is adjacent to the support layer.

3. The anti-static article according to claim 1, wherein the electrically conductive layer has a surface conductivity of between 10² and 10¹⁰ ohms/square.

4. (canceled)

5. (canceled)

6. The antistatic article according to claim 3, wherein the electrically conductive layer has a surface conductivity of between 10⁵ and 10⁶ ohms/square

7. (canceled)

8. The antistatic article according to claim 1, wherein the electrically conductive layer consists of an electrically conductive polymer or an electrically conductive polymer composite

9. The antistatic article according to claim 1, wherein the electrically conductive polymer comprises a conjugated conducting polymer, a charge transfer polymer, a charged polymer, an electrically conductive filled polymer, or mixtures thereof.

10. The antistatic article of claim 9, wherein the conjugated conductive polymer comprises poly(phenylenevinylenes), polyfluorenes, poly(spirobifluorenes), polythiophenes, poly(p-phenylenes), poly(anilines), poly(pyrroles), copolymers thereof, or mixtures thereof.

11. (canceled)

12. The antistatic article of claim 9, wherein the charged polymer comprises a cationic polymer or an anionic polymer.

13. (canceled)

14. The antistatic article of claim 12, wherein the charged cationic polymer comprises ammonium, phosphonium or sulfonium groups.

15. The antistatic article of claim 14, wherein the charged cationic polymer comprises 2-hydroxyethyl methacrylate (HEMA), 2-acrylamido-2-methylpropane sulfonic acid (AAMPS), 3-methacryloylaminopropyl-trimethyl ammonium chloride (MAPTAC), or N,N-diallyl-N,N-dimethyl ammonium chloride (DADMAC).

16. (canceled)

17. The antistatic article according to claim 9, wherein the charge transfer polymer comprises tetrathiofulvalene and 7,7,8,8-tetracyano-p-quinodimethane.

18. The antistatic article according to claim 9, wherein the electrically conductive polymer comprises a doped conductive polymer.

19. The antistatic article according to claim 18, wherein the doped conductive polymer comprises polyaniline, polypyrrole, polyacetylene, polyparaphenylene, polythiophene, or derivatives or mixtures thereof, and wherein the dopant comprises 2-naphthalene sulfonic acid (NSA), 9,10-anthraquinone-2-sulfonic acid sodium salt (AQSA-Na), p-toluenesulfonic acid or its sodium salt (PTSA or PTSA-Na), benzenesulfonic acid (BSA), or dodecylbenzene sulfonic acid or its sodium salt (DBSA and DBSA-Na).

20. The antistatic article according to claim 1, wherein the electrically conductive polymer composite comprises,
i) the electrically conductive polymer as defined in claim 9, or a conductive clay; and
ii) a pigment material; and
iii) a binder.

21. The antistatic article according to claim 20, wherein the pigment comprises kaolin clay, magnesium silicate, talc (hydrous magnesium silicate), titanium dioxide and barium sulphate, plastic pigment, or mixtures thereof.

22. The antistatic article according to claim 20, wherein the binder comprises synthetic latex, starch, polyvinyl alcohol, soy protein, carboxyl methyl cellulose (CMC), or mixtures thereof.

23. The antistatic article according to claim 20, wherein the electrically conductive polymer composite comprises,
i) 0.1 to 50% of the electrically conductive polymer as defined in claim 9; and
ii) 20 to 90% of the pigment material; and
iii) 1 to 30% of the binder.

24. The antistatic article according to claim 1, wherein the support layer comprises a cellulosic paper layer, hemicellulosic paper layer, a calcium carbonate paper layer, or a biodegradable polymer layer.

25. The antistatic article according to claim 24, wherein the biodegradable polymer layer comprises polycaprolactone (PCL), polyvinyl alcohol (PVOH, PVA, or PVAI), and polylactic acid or polylactide (PLA).

26. (canceled)

27. (canceled)

28. (canceled)

29. The antistatic article according to claim 1, further comprising one or more of a vapor barrier layer, a moisture barrier layer, an oxygen barrier layer, a heat sealable polymer layer, a second electrically conductive layer or a second support layer.

30. (canceled)

31. (canceled)

32. The antistatic article according to claim 1, wherein the antistatic article is in the form of a bag, a box, an envelope or a fill sheet.

33. An anti-static bag, comprising,
i) an electrically conductive layer as defined in claim 1; and
ii) a support layer as defined in claim 24.

34. An anti-static bag, comprising,
i) a first electrically conductive layer as defined in claim 1;
ii) a heat sealable polymer layer;
iii) a first support layer as defined in claim 24;
iv) a vapor barrier layer;
v) a second support layer as defined in claim 1; and
vi) a second electrically conductive layer as defined in claim 1.
